(19) United States
(12) Patent Application Publication
(10) Pub. No.: US 2026/0149935 A1
(43) Pub. Date: May 28, 2026

(54) HEARING INSTRUMENT SYSTEM

(71) Applicant: Sivantos Pte. Ltd., Singapore (SG)

(72) Inventors: Bernd MEISTER, Erlangen (DE); Sascha BILERT, Erlangen (DE); Tobias WURZBACHER, Erlangen (DE)

(21) Appl. No.: 19/399,767

(22) Filed: Nov. 25, 2025

(30) Foreign Application Priority Data
Nov. 25, 2024 (DE) 10 2024 211 286.0

(51) Int. Cl. H04R 25/00; H04R 1/10; H04R 1/12; H04R 3/00

(52) U.S. Cl. CPC H04R 25/305; H04R 1/1025; H04R 1/12; H04R 3/007; H04R 2225/31; H04R 2225/41

(57) ABSTRACT

A hearing instrument system has a hearing instrument with a housing and at least one loudspeaker arranged in the housing connected to an environment of the housing via a sound conduction channel. The hearing instrument system further has a controller configured to ascertain whether at least one starting condition for initiating a cleaning mode for the sound conduction channel is present. If the or one of multiple, as appropriate, starting conditions is present, initiate the cleaning mode, and during the cleaning mode, output an audio signal with a specified waveform with a varying period using the loudspeaker.

### CROSS-REFERENCE TO RELATED APPLICATION

This application claims the priority, under 35 U.S.C. § 119, of German Patent Application DE 10 2024 211 286.0, filed Nov. 25, 2024; the prior application is herewith incorporated by reference in its entirety.

### FIELD AND BACKGROUND OF THE INVENTION

The invention relates to a hearing instrument system.

Hearing instruments ordinarily are for outputting an audio signal to the auditory system of the wearer of the hearing instrument. Outputting is performed using an output transducer, usually acoustically via airborne sound using a loudspeaker (herein also referred to as an “earphone” or “receiver”). Such hearing instruments are often employed as what are known as hearing assistive devices (also called hearing aids for short). The hearing instruments commonly comprise an acoustic input transducer (in particular a microphone) and a signal processor configured to process the input signal (also: microphone signal) produced from the ambient sound by the input transducer applying at least one ordinarily user-specific stored signal processing algorithm such that a hearing impairment of the wearer of the hearing device is at least partially compensated for. In particular in the case of a hearing assistive device, the output transducer, in addition to being a loudspeaker, may alternatively also be what is known as a bone conduction receiver or a cochlear implant configured to mechanically or electrically couple the audio signal into the wearer's auditory system. In addition, there are hearing instruments which protect or improve the hearing ability of users with normal hearing, for example intended to enable improved speech comprehension in complex hearing situations. Such devices are also referred to as “personal sound amplification products” (PSAP for short). In particular, the term hearing instruments additionally includes devices such as, e.g., what are known as tinnitus maskers, headsets, headphones (“earbuds,” among others), and the like.

Typical designs of hearing instruments, in particular hearing aids, are behind-the-ear (“BTE”) and in-the-ear (“ITE”) hearing instruments. These terms are directed at the intended wearing position. Behind-the-ear hearing instruments have a (main) housing which is worn behind the auricle. They can be distinguished into models where the loudspeaker is arranged within this housing—the sound is ordinarily output to the ear using a sound tube worn within the auditory canal—and into models having an external loudspeaker being placed in the auditory canal. In-the-ear hearing instruments, however, have a housing worn within the auricle or even entirely within the auditory canal.

As is known, hearing instruments which use a loudspeaker require an opening through which the airborne sound generated using the loudspeaker can arrive at the environment, in particular at the user's auditory system. Each opening, however, also offers a way for contamination to penetrate into the hearing instrument, at least up to or even inside the loudspeaker. For example, such contamination is moisture (liquid or steam) or particles (dust, fluff, sand, or the like), but often also cerumen. Due to progressive miniaturization and also the housings usually being otherwise sealed as tightly as possible, manual drying—except when applying a blower—or cleaning is usually associated with a high risk of causing damage. However, such contamination leads to loss of function due to (partial) clogging of openings, also of sound conduction channels, for example, or even to damage (e.g., corrosion) at the loudspeaker itself if such contamination can penetrate all the way into or onto the loudspeaker. Thus, removing such contamination is in the interest of the respective user.

### SUMMARY OF THE INVENTION

It is therefore the object of the invention to enable an improvement when removing contamination.

According to the invention, this object is attained by a hearing instrument system with the features of the independent hearing instrument system. Advantageous embodiments and developments of the invention, some of which are in themselves inventive, are set forth in the dependent claims and in the following description.

The hearing instrument system according to the invention has a hearing instrument and at least one loudspeaker. This loudspeaker is acoustically connected to an environment of the hearing instrument via a sound conduction channel. The hearing instrument system further has a controller configured to ascertain whether at least one starting condition for initiating (that is, in particular, for activating) a cleaning mode for the sound conduction channel is present, and upon the or one of multiple, as appropriate, starting conditions being present, initiate (in particular activate) the cleaning mode, and during the cleaning mode, output an (in particular acoustic) audio signal (also: “sound signal”) with a waveform using the loudspeaker. The controller is configured to vary a period of the waveform while the audio signal is output.

Preferentially, the controller is also configured to, for the waveform of the audio signal, select and specify a rise duration and/or a fall duration of signal edges of the audio signal, in particular to alter them while outputting the audio. The rise and fall durations are preferentially varied within typical durations for an audio signal—for instance, between 50 μs and 5 ms, in particular between 200 μs and 5 ms. Optionally, in particular as described in greater detail in the following, the controller is configured to alter the rise duration and/or the fall duration of the signal edges within the scope of altering the period. At least for a (in particular constant) specified maximum amplitude (generally also referred to as a volume or even as a signal level), a slope of the signal edges changes as the period changes, and hence, so does their rise duration or fall duration, respectively. In additional cases, the controller may also be configured to select the rise and fall durations, respectively, of the signal edges as a function of, for example, fouling and to alter them as appropriate. In the latter case, in particular, the period therefore changes accordingly (in particular when maintaining the specified maximum amplitude).

Here and in the following, in particular, the term “signal edge” is understood to mean an edge of an oscillating time signal. Consequently, the audio signal is preferentially also to be understood to mean an oscillating time signal.

Preferentially, a maximum amplitude (i.e., a maximum value for the amplitude), which is in particular constant over the duration of the audio signal, is specified (in particular by the controller) for the audio signal. Amplitude values ordinarily rising or falling at the beginning and end of the audio signal (due to “switch-on” or “switch-off” operations) are to be neglected.

According to a particularly appropriate implementation, the controller is configured to output the audio signal with a varying period in the form of at least one chirp. Here and in the following, in particular, a chirp is understood to mean an acoustic event, in particular an audio signal, having its frequency (and hence also its period) changing over time. In particular, the frequency may increase or decrease—preferentially with an invariable waveform and/or amplitude (in particular at least the maximum amplitude as described above) of the signal. That is, in particular, a chirp—at least within the scope of this description—is described by means of multiple properties (parameters) such as a duration (in particular usually multiple seconds, for example, 3 to 20 seconds), a starting frequency and an end frequency, and its underlying waveform. In particular, with a chirp, the frequency is changed continuously from the starting to the end frequency. Thus, the chirp is preferentially distinct from two consecutive audio signals with different (constant) frequencies.

Preferentially, the hearing instrument system has a housing for the

hearing instrument (i.e., the housing is part of the hearing instrument). Optionally, the loudspeaker is arranged in the housing. The housing may also serve as a housing for multiple components of the hearing instrument (for example, for the controller, a microphone, and also for an energy source, such as, e.g., a battery) or also as a housing (in this case preferentially as a housing add-on) for the loudspeaker only. In the latter case, in particular, this housing add-on forms an earmold configured and provided for holding the loudspeaker in a user's ear, preferentially auditory canal.

The sound conduction channel may, in a simplest variant, be a sound opening in the housing (or correspondingly also in the housing add-on) in which a sound output of the loudspeaker—or a “spout” or the like—is located or which is abutted by a corresponding sound output opening of the loudspeaker at the (housing) interior side. However, the sound conduction channel may also be formed by a tube-like or pipe-like component (in particular separate from the loudspeaker) connecting the sound output opening of the loudspeaker to the sound opening of the housing (in particular of the earmold) or even to a further sound output opening (the latter applies, in particular, in the case of a sound tube).

Due to its sound pressure and/or the vibrations elicited thereby in the sound conduction channel, the audio signal advantageously effects transport of the fouling. This (material) transport may be used to clear the sound conduction channel of the fouling (that is, in particular, to clean it) or to remove it at least partially or to distribute it so that audio output through the sound conduction channel is enabled and/or penetration of the fouling all the way to the loudspeaker is prevented. Thus, the audio signal may also be referred to as an (acoustic) “cleaning signal” in the following.

A chirp has the advantage that the cleaning signal is not only emitted at a fixed frequency but across a frequency range, i.e., with at least two frequencies. This may improve the transport effect, in particular as fouling is usually not homogeneous in nature, and as a result, various parts of the fouling “respond” to (that is, in particular, may be moved at) different frequencies.

According to a particularly appropriate implementation, the controller is configured to ascertain a type of fouling (contamination) of the sound conduction channel and to select a waveform for the audio signal, in particular the chirp, as a function of the fouling. This is underpinned by the finding that for different types of fouling, that is, for example (in particular dry) particles (e.g., dust) or a liquid (e.g., sweat, water), different waveforms have varyingly strong effects regarding transport of the respective fouling through the sound conduction channel.

According to a further appropriate implementation, the controller is configured to, in addition or as an alternative to selecting the waveform, select a frequency range, i.e., in particular the starting and end frequencies, for the audio signal, in particular the chirp, as a function of the fouling. This implementation is also based on the finding that liquids and particles in the sound conduction channel have varyingly strong reactions to respective different frequencies, and as a result, transport through the sound conduction channel may be affected correspondingly.

For ascertaining the type of the fouling of the sound conduction channel, according to a particularly appropriate implementation, the controller is configured to perform (in particular acoustic) feedback measurement, in particular what is known as open-loop gain measurement. In the event that the hearing instrument comprises an associated microphone, in particular, is designed as a hearing assistive device, such a feedback measurement is known to take place such that the hearing instrument is put down independently or in a reference housing (for example, in a housing of a charger) and an audio signal with increasing amplification is output until feedback of the output audio signal into the microphone itself is sensed. A transfer function for feedback may be determined from such a measurement. In the present case, in particular, the controller is configured to ascertain from comparisons with stored references or on the basis of training data and a learned algorithm, for example, whether the sound conduction channel is clear, is occupied by dry material (particles), and/or by a liquid. As an alternative to the internal microphone, an external microphone may also be used for this purpose. For example, a microphone of a smartphone (or of a comparable device or computer) or even in a charger for the hearing instrument may be used for this purpose having a sensing behavior which is known to the controller or which is made known when performing the measurement.

As an alternative or even in addition to the feedback measurement described above, according to a further appropriate implementation, the controller is configured to, for ascertaining the type of the fouling, ascertain any resonance detuning, in particular any mechanical, magnetic, and/or electrical resonance detuning. Mechanical resonance detuning may be ascertained, for example, using an accelerometer from an alteration of an oscillation of the hearing instrument, in particular of the housing or even of the loudspeaker. This is because any attachment of material (particles and/or moisture) in the sound conduction channel regularly leads to altered oscillatory behavior. Magnetic and electrical resonance, in particular of the loudspeaker, behave in a comparable manner.

Within the scope of a further alternative or additional implementation, the controller is configured to, for ascertaining the type of the fouling, evaluate an optical recording, i.e., an image, which is (has been) acquired using a separate camera, in particular a camera of a smartphone, a tablet, a computer, or the like, and transmitted to the controller. The controller preferentially applies pattern detection methods, a comparison with reference images, or the like. For instance, the controller is configured to instruct the user of the hearing instrument system or at least of the hearing instrument to make a corresponding recording of an interior of the sound conduction channel. This recording is subsequently made available to the controller for evaluation (for example, by the user or alternatively, within the scope of a special application (“app”)).

Preferentially, the controller forms an element (a component) of the hearing instrument itself. In a preferred design, at least essentially, the controller is formed by a microcontroller with a processor and a data storage in which the functionality for performing the procedure according to the invention described here and in the following is implemented by programming in the form of operating software (firmware) so that the controller—optionally in interaction with the user of the hearing instrument—performs the steps described automatically when executing the operating software in the microcontroller. Within the scope of the invention, the controller may alternatively also be formed by a non-programmable electronic component, e.g., an ASIC, in which the functionality for performing the cleaning mode described here and in the following is implemented by means of circuitry. Alternatively, however, the controller may be formed separate from the hearing instrument and may, for example, be implemented in the smartphone (or a comparable device, for example, a computer, a tablet, or the like) mentioned above (in particular using a software application). In this case, the smartphone forms part of the hearing instrument system—at least during intended pairing with the hearing instrument which has been entered into for controlling the latter. In this case, the smartphone appropriately relays corresponding commands of the controller for output of the chirp (or optionally also a “streaming signal” corresponding to the cleaning signal) to the hearing instrument (in particular to an internal hearing instrument controller associated therewith), preferentially using radio coupling.

According to a preferred implementation, the controller is configured to select a square form or a sawtooth form as the waveform for the audio signal, in particular for the chirp. Both waveforms have a large number of harmonic oscillations, which in turn has a positive effect on sound-driven transport of the fouling, in particular in case of moisture. A triangle form (in particular with correspondingly selected slopes or rise and fall durations of the signal edges, respectively) also has a large number of harmonic oscillations and is thus optionally employed. In principle, a sine may also be selected as the waveform for the audio signal, in particular for the chirp. As is known, square, triangle, and sawtooth forms are distinguished in their respective slopes (rise and fall durations) which are preferably selected by the controller.

According to an appropriate further development, the controller is configured to select the sawtooth form as the waveform for the audio signal, in particular for the chirp. In this case, the controller is also configured to select a slope of the rising edge (and hence, in particular in combination with a signal level which is in particular specified, preferably constant—here preferentially to be understood as the maximum amplitude of the audio signal—, also its rise duration) and the falling edge (and hence in particular, in particular in combination with the signal level which is in particular specified, preferably constant, its fall duration) of the sawtooth as a function of a transport direction within the sound conduction channel. As a result, for a “positive” transport direction, i.e., a direction away from the loudspeaker, the controller is preferentially configured to specify a steep (optionally approximately perpendicular) rising edge and a flat falling edge (each in comparison with one another) of the waveform. Preferentially, the falling edge is significantly flatter (that is, in particular, the slope is flatter by a factor of two) than the rising edge. For a negative transport direction, i.e., in a direction towards the loudspeaker, the controller is configured to, in particular, —preferentially correspondingly the other way around—specify the rising edge to be flatter than the falling edge of the waveform. The negative transport direction may be advantageous in that, due to any stuck or caught particles, their (material) transport may come to a halt in the positive transport direction. Such a “congestion” may be dissolved, for example, by reversing the transport direction, preferably multiple times.

Appropriately, the controller is configured to, within the scope of the cleaning mode, select the audio signal or at least two consecutive audio signals (in particular, to specify their respective slopes, as described above) such that the transport direction changes. Optionally, the controller is configured to, within the scope of the cleaning mode, for example, as part of the audio or cleaning signal or even as a standalone audio signal, output a signal adapted for the negative transport direction as described above, in particular a chirp, for a particularly brief time span of, for example, 0.25 to 2 seconds, and in particular, following this, a further signal (partial signal or standalone audio signal) for the positive transport direction. Appropriately, the controller is configured to output the audio signal with a partial signal for the negative transport direction for a short time, for example, for up to 3 seconds, or also to output one respective (in particular brief in such a way) audio signal alternately for both transport directions, that is, in particular, to alternately output signals multiple times for the positive and the negative transport direction, in particular to dissolve a congestion as described above. This is optionally selected by the controller within the scope of the cleaning mode in general or upon particularly severe fouling (which may, for example, be detected from the feedback measurement described above). Alternatively, the controller selects such changing of the transport direction in particular when the controller establishes after the cleaning mode (which has optionally been performed with only one audio signal for the positive transport direction)—in particular from a further feedback measurement or the like—that the fouling is still present. Preferentially, after changing the direction, in particular multiple times, the controller finally selects a partial signal (or audio signal) for the positive transport direction to transport the dissolved fouling out of the sound channel.

Within the scope of the cleaning mode, the controller is optionally configured to output multiple consecutive audio signals, optionally having different properties.

In addition, or as an alternative, the controller is appropriately configured to calculate the absolute value (abs(...)) of the selected waveform (that is, for example, abs(sin(t)) in case of a sine) and to output it to the loudspeaker to elicit a positive transport direction. Comparably, in particular, the controller is also configured to calculate the negative absolute value (-abs(...)) of the waveform and to output it to elicit transport in a negative direction.

Preferentially, the controller is configured to select a frequency framework range of 50 Hz to 2000 Hz for the chirp. Here and in the following, in particular, a “frequency framework range” is understood to mean the upper and lower limits of frequencies within which the chirp may be selected by the controller. The frequency may be selected by the controller to be both decreasing and increasing.

For instance, the controller is configured to select a frequency framework range for the chirp of 550 Hz to 50 Hz for fouling in the form of a liquid (i.e., if the controller ascertains that a liquid is present in the sound conduction channel as the fouling). In the event that the controller ascertains that fouling in the form of dry particles is present in the sound conduction channel, in addition or as an alternative, the controller is configured to, for instance, select a frequency framework range for the chirp of 100 Hz to 1500 Hz. In particular, in case of a liquid in the sound conduction channel, the controller is configured to select the starting frequency to be in the range of up to 550 Hz and the end frequency to be in the range of about 50 Hz. For dry fouling, the starting frequencies are in the range of 100 Hz and the end frequencies are in the range of 1500 Hz. Thus, in case of a liquid, the frequency of the chirp decreases over its duration. In case of dry fouling, in contrast, the frequency preferentially increases. In principle, the starting and end frequency values in both cases (dry particles and liquid) may also be reversed (i.e., the starting frequency is “low” and the end frequency is “high” or the other way around).

According to an appropriate further development, furthermore, the controller is also configured to assign different frequency ranges within the frequency framework range to the chirp as a function of a length of the sound conduction channel, in particular a frequency range shifted towards lower frequencies for a comparatively large length. Said differently, the controller causes the loudspeaker to output a chirp with comparatively low starting and end frequencies if the sound conduction channel is comparatively long. Optionally, for this purpose, a (lookup) table is stored in a memory of the controller storing corresponding starting and end frequencies for different lengths of the sound conduction channel. In particular, the length of the sound conduction channel may be relevant with hearing instruments to be worn behind the ear as sound tubes are usually employed here which connect the loudspeaker arranged in the housing (“main housing”) of the hearing instrument to the ear (auditory canal) of the user when inserted as intended. Here, standardized lengths of such sound tubes are usually available. They are often provided with encoding (for example, a combination of numbers and/or letters) which is forwarded to the controller by the user or a specialist so that the controller can correspondingly read from the table described above.

According to a particularly preferred implementation, the controller is configured to, as the audio signal, superpose two chirps differing regarding their respective frequency ranges within the frequency framework range and/or in a chirp duration (also referred to as “superposition” in the following), and to output them using the loudspeaker. In particular, the controller is configured to “design” both chirps as described here and in the following. That is, preferentially, the controller is configured to specify each of these two chirps differently with regard to the parameters described, that is, in particular, regarding their starting and end frequencies, their chirp duration, and optionally also their waveform. Such a superposition of (at least) two chirps is based on the finding that a maximum sound output pressure of a loudspeaker is regularly dependent on the frequency. Thus, in case of superimposition of two frequency-shifted chirps, a higher sound output pressure can also be produced for the frequency portions of a chirp for which only a lower value would otherwise be possible. Moreover, sound propagation speed is also different for different frequencies. This may advantageously be used to add wavefronts at certain points (longitudinal positions) along the sound conduction channel and, as a result, locally amplify their effect. For example, superimposition of (at least) two chirps may be used to allow added wavefronts to successively “migrate” through the sound conduction channel. Use of different chirps in superposition thus also has the advantage that, due to their differences, various “fouling situations” in the sound channel (position, degree of possible clogging—complete or partial) may be “processed,” in particular even without having exact knowledge of the fouling situation.

In one exemplary embodiment for two superimposed chirps, for the case of a hearing instrument to be worn behind the ear and water as the fouling, the controller uses two chirps having a square-wave signal as the waveform. The first chirp has a starting frequency of 410 Hz and an end frequency of 80 Hz with a chirp duration of 5 seconds (after which the chirp is repeated). The second chirp has a starting frequency of 520 Hz and an end frequency of 90 Hz with a chirp duration of 10 seconds.

Optionally, the controller repeats the audio signal, in particular the chirp or the superposed chirps, appropriately even multiple times.

According to an appropriate implementation, the controller is configured to detect an intended wearing situation of the hearing instrument and to block the cleaning mode or to recommend (in particular to the user) taking out the hearing instrument. For instance, the hearing instrument has an inertial measurement unit, in particular a 3D accelerometer, with the controller inferring the orientation of the hearing instrument in space from its output signal. Preferentially, the controller is configured to detect a typical orientation for the (intended) wearing situation of the hearing instrument at the head, in particular at the user's ear, in space (for example, from one or more reference values) and thereafter to block the cleaning mode or to recommend taking it out. In particular, the controller is configured to recommend putting the hearing instrument into a charger (optionally in addition to taking it out). This implementation has the advantage that as a result, use of comparatively high sound levels, which might otherwise lead to damage to the user's auditory system, for the cleaning mode is unproblematic.

Preferentially, the controller is configured to actuate the loudspeaker to output the audio signal at a sound pressure level of 75 to 145 dBSPL, for example, between 80 and 140 dBSPL. A minimum and/or maximum value of the sound pressure level often depends on the hearing instrument, in particular on the length, diameter, and/or material of the sound conduction channel, and may be ascertained for the respective hearing instrument by means of simple experimentation.

According to an appropriate implementation, the controller is configured to, in addition to selecting the waveform and the frequency range as described above, i.e., in particular the starting and end frequencies, as a function of the type of the fouling, also select an intensity for the cleaning mode. In particular, this intensity is variable by means of the parameters (selectable by the controller) of total duration of the respective cleaning signal or of the cleaning mode (that is, within the scope of the exemplary embodiments above, how often the or the respective audio signal, in particular the respective chirp, is repeated) and/or volume value.

According to an optional implementation, the controller is configured to perform a drying mode before the cleaning mode (i.e., before activating it). For this purpose, the controller actuates the loudspeaker to output a (drying) audio signal at a frequency below 20 Hz for the drying mode. This frequency is not or almost not audible to the human auditory system so that the drying mode may still be performed even while using the hearing instrument as intended. This (drying) audio signal preferentially effects “sound-driven” vaporization of moisture, in particular due to air pressure fluctuations contingent thereon, but also—in particular if long-lasting operation of the loudspeaker is present—temperature-contingent drying due to an increased operating temperature (in particular beyond an ambient temperature value). For example, this may address any fouling with moist dust in a particularly effective way as the moisture can be removed during the drying mode and dry particles can be effectively conveyed out of the sound conduction channel during the following cleaning mode.

According to an advantageous implementation, the controller is configured to utilize positioning the hearing instrument in a charger or initiating a charging operation in the charger as the starting condition. I.e., the controller only initiates the cleaning mode when the hearing instrument is placed in the charger—this may be detected, for example, by means of coupling to galvanic charging contacts or even by means of coupling of induction coils—or even only when the charging operation is initiated. The latter is convenient at least in that energy supply for the cleaning mode, which potentially requires more energy as compared to normal operation of the hearing instrument, is ensured then. Further, this often also decreases any acoustic disturbance to the user as the charger preferentially has a closable and hence acoustically at least partly encapsulated housing. Optionally, this starting condition may also solely be utilized for ascertaining, as described above, whether fouling is present so that the controller initially checks for presence of fouling in terms of this starting condition and activates the cleaning mode (in the sense of a second starting condition) only when fouling has been ascertained.

As an alternative starting condition, the controller optionally utilizes a wearing duration which has elapsed since the most recent activation of the cleaning mode or lapse of a specified waiting time (for example, 24 or 48 hours). In this case, too, in terms of this alternative starting condition, the check for presence of fouling appropriately takes place upstream. Besides, detected ambient situations may also be utilized as a starting condition at least for the check. For example, increased activity or exercise (e.g., running, cycling, swimming), which can usually be ascertained from the signal of the inertial measurement unit described above using corresponding algorithms and allows an inference of sweat and/or the risk of external moisture, may be utilized as the starting condition. Also, presence of rain, for example, which in case of a hearing assistive device may be derived, for example, from microphone data or be ascertained in a simple manner from weather data which is, for example, gathered using the smartphone, may be utilized as one such starting condition.

Further, the controller is also configured to utilize activation of the cleaning mode by the user as the starting condition. In this case, the controller preferentially performs the check for presence of fouling as described above and subsequently correspondingly selects the parameters (i.e., the waveform, the frequency range, etc.) for the (or the respective) audio signal as described above. Preferentially, in case of absence of fouling, the controller is configured to prompt the user for a decision as to whether the cleaning mode should be performed in spite of this. Optionally, a “general cleaning signal” is stored for this which, for example, contains a first partial cleaning signal for moisture and a subsequent second partial cleaning signal for dry particles.

According to a further advantageous implementation, the controller is configured to superpose the (or each, as appropriate) audio signal (cleaning signal) described above with a further acoustic signal, in particular with what is known as a jingle. This can be used to mask or “conceal” the cleaning signal, which acoustically usually sounds rather strange or annoying to the user, and as a result, decrease any disturbance (even if only perceived subjectively).

Within the scope of the invention, it is also conceivable for a reservoir (for example, in the form of a chamber in communication with the sound conduction channel) for particles or optionally also moisture to be arranged at the sound conduction channel—preferentially at a short distance from the loudspeaker as compared to the length of the sound conduction channel. In the case of the negative transport direction, fouling, in particular particles, may be captured here and be emptied by the user at regular intervals.

The term “user” is to be understood to be an equivalent, shortened designation for a person using the hearing instrument without any indication as to that person's gender.

Here and in the following, in particular, the conjunction “and/or” is to be understood such that the features linked by this conjunction may be formed both jointly and as alternatives to one another.

Other features which are considered as characteristic for the invention are set forth in the appended claims.

Although the invention is illustrated and described herein as embodied in a hearing instrument system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic illustration of a hearing instrument system with a hearing instrument;

FIGS. 2-4 are graphs each showing a waveform of an audio signal output using a loudspeaker of the hearing instrument; and

FIGS. 5 and 6 each show a schematic, diagrammatic illustration of the use of two different audio signals for acoustically driven transport of fouling through a sound conduction channel.

Corresponding parts and sizes are provided with the same reference symbols throughout the figures.

### DETAILED DESCRIPTION OF THE INVENTION

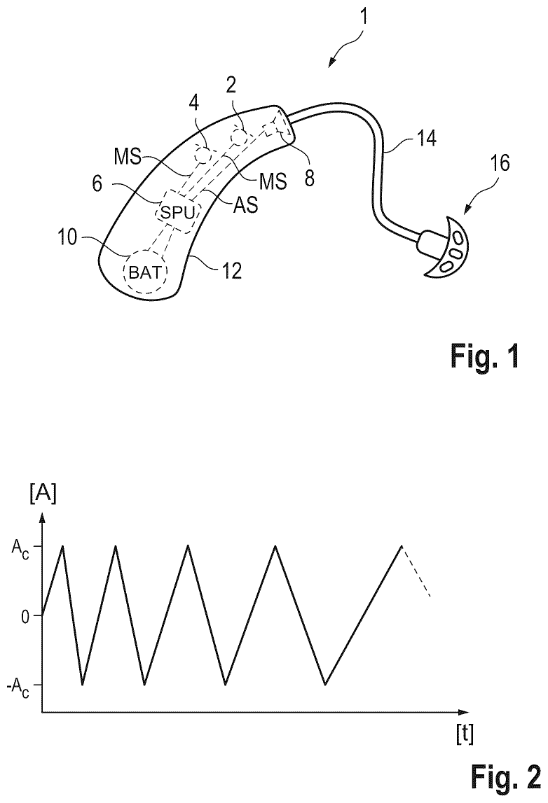

Referring now to the figures of the drawings in detail and first, particularly to FIG. 1 thereof, there is shown schematically a hearing instrument system having a hearing instrument 1 in the form of a hearing assistive device to be worn behind the ear. The hearing instrument 1 has—relative to an intended wearing position at a user's head—a front microphone 2 and a rear microphone 4. Furthermore, the hearing instrument 1 has a signal processor 6, and a loudspeaker 8 and an energy source 10 (here a rechargeable battery). The microphones 2 and 4, the signal processor 6, the loudspeaker 8, and the energy source 10 are arranged in a housing 12 of the hearing instrument 1.

The signal processor 6 is configured to process ambient sound sensed using the microphones 2 and 4 and converted into microphone signals MS as a function of a hearing impairment of the user, specifically, filter and amplify it dependent on the frequency, and to output it as an output signal AS to the loudspeaker 8. The latter in turn converts the output signal AS into sound for output to the user's auditory system. The sound output by the loudspeaker 8 is output to the auditory canal using a sound tube 14 connected to the housing 12 which is worn positioned in the auditory canal using an earmold 16. The sound tube 14 forms a sound conduction channel acoustically connecting the loudspeaker 8 to the environment.

A type of mechanical filter (for example, a type of mesh) is usually arranged in the sound tube 14 on the side of the earmold to prevent any cerumen from entering. In spite of this, moisture and/or dust or the like may enter the sound tube 4 as contamination (fouling). This is the case, for example, when exercising (due to transpiration, for example).

The signal processor 6 (forming a controller for the hearing instrument 1 and the hearing instrument system) is configured and provided to perform “cleaning” of the sound tube within the scope of a cleaning mode as described in greater detail in the following. To achieve this, the signal processor 6 checks for presence of one or more starting conditions for initiating the cleaning mode, if the or the respective starting condition is present, initiates the cleaning mode, and within the scope thereof, outputs (at least in particular) an audio signal (in the following: “cleaning signal”) using the loudspeaker 8. The cleaning signal is formed by or contains what is known as a chirp.

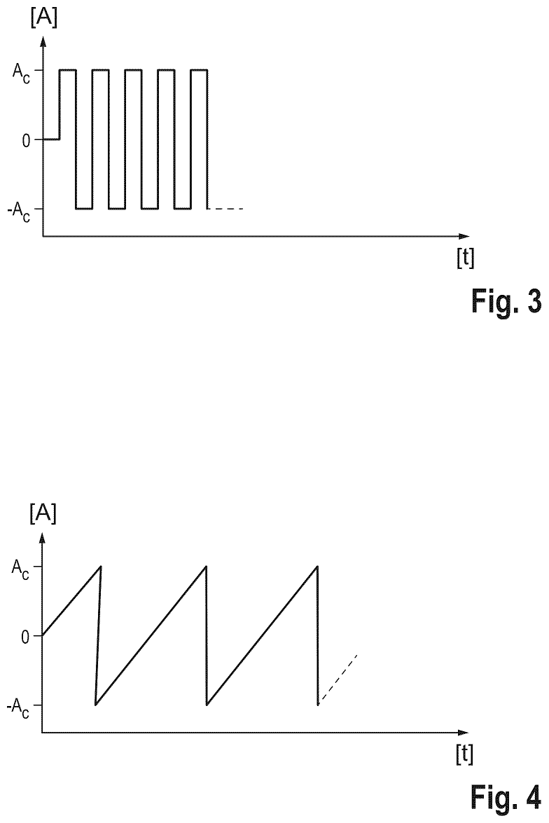

A chirp is understood to mean an acoustic signal (that is, a sound signal) having its frequency changing, for example, increasing or decreasing, over time. In FIG. 2, as an example, in a diagram plotting a signal amplitude A versus time t, a chirp is depicted on the basis of a triangle waveform. The amplitude Ac of the chirp is constant, with the frequency decreasing—continuously here. The signal processor 6 is configured to output at least one chirp with a constant waveform and a constant amplitude (in particular, a constant maximum value of the amplitude) as the cleaning signal. However, the signal processor 6 is also configured to specify the waveform, a starting and an end frequency, a signal duration (chirp duration), and optionally also a volume value (amplitude or level) as a function of a type of the contamination. The signal processor 6 is configured to proceed according to the steps described in greater detail in the following.

According to a first exemplary embodiment, a starting condition is formed by the hearing instrument 1 being placed in a charger (not depicted in greater detail; also referred to as a charging box). The signal processor 6 detects this based on galvanic charging contacts being contacted or inductive coupling to a charging coil being present. If this starting condition is present, the signal processor 6 initially performs a check as to whether any contamination of the sound tube 14 is present. To achieve this, the signal processor 6 performs feedback measurement, specifically open-loop gain measurement. By means of comparison to stored data (in particular results of comparative measurements), the signal processor 6 may ascertain whether any contamination is present at all and whether moisture and/or dry particles (for example, dust, sand, . . . ) are present in the sound tube 14 as contamination.

If the signal processor 6 establishes that contamination is present, the signal processor 6 utilizes this as the (second or further) starting condition and activates the cleaning mode.

Within the scope of the cleaning mode, the signal processor 6 selects the properties of the chirp described above as a function of the type of the contamination.

The signal processor 6 selects the waveform from signal forms having many harmonics. In addition to the triangle form depicted in FIG. 2, they are, among others, a square form depicted (schematically for a constant frequency) in FIG. 3, and a sawtooth form depicted (schematically for a constant frequency) in FIG. 4.

In addition, the signal processor 6 selects a starting frequency and an end frequency, and a chirp duration (i.e., the duration in which the frequency is altered from the starting frequency to the end frequency).

In simple exemplary embodiments, for a liquid having entered into the sound tube 14, the signal processor 6 selects a chirp with one of the three waveforms, a starting frequency of 550 Hz and an end frequency of 50 Hz, and a chirp duration of 5 seconds. This chirp is played by the signal processor 6 (as a partial signal of the cleaning signal or as multiple cleaning signals within the scope of the same cleaning mode) multiple times in succession, for example, 4 times. Thereafter, the signal processor 6 again performs open-loop gain measurement, that is, it checks whether the contamination has already been remedied, and repeats the chirps (i.e., the or the respective cleaning signal) again, as appropriate.

If, in contrast, the signal processor 6 establishes that dust, for example, is present in the sound tube 14, the signal processor selects a chirp with one of the three waveforms, preferentially a sawtooth waveform, a starting frequency of 100 Hz, and an end frequency of 1500 Hz. I.e., the frequency becomes greater here. As a signal duration, the signal processor selects 5 to 20 seconds here.

For particularly effective cleaning, the signal processor 6 “superposes” at least two chirps (superposition). For a hearing assistive device to be worn behind the ear, as described in FIG. 1, the signal processor 6 selects two chirps with a square waveform of the same amplitude Ac for cleaning the sound tube 14 of a liquid (water). The first chirp lasts 5 seconds, the second one lasts 10 seconds. Thereby, the first chirp is already played twice while the second one is played. The first chirp has a starting frequency of 410 Hz and an end frequency of 80 Hz while the second chirp starts at 520 Hz and ends at 90 Hz.

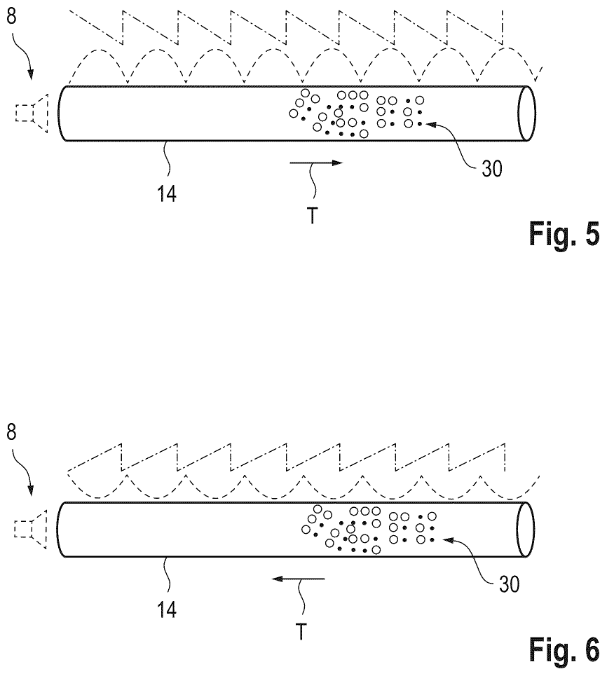

FIGS. 5 and 6 each depict two exemplary embodiments for “control” of a transport direction T of the respective contamination, implied by dots 30 here. FIG. 5 depicts an implementation where the transport direction T is directed away from the loudspeaker 8. For this purpose, in an exemplary embodiment, the signal processor 6 uses a chirp (the varying period or frequency, respectively, is not depicted in greater detail here) with a sawtooth waveform. A slope of the rising edge of the curve (wave, oscillation) is selected to be distinctly steeper than it is at the falling edge. Alternatively (or in case of superposition even additionally), the signal processor 6 calculates an absolute value of the selected waveform, here of the sawtooth (that is, e.g., abs(sawtooth(t)) here), and outputs it using the loudspeaker 8.

In FIG. 6, for the transport direction T of the opposite orientation, the “sawtooth profile” is correspondingly selected to be the other way around. That is, here, the rising edge is flatter than the falling edge of the signal. Alternatively, the signal processor calculates the negative absolute value of the sawtooth (-abs(sawtooth(t))), and outputs it using the loudspeaker.

In an optional exemplary embodiment, the controller is configured to change the transport direction T multiple times by outputting multiple ones of the cleaning signals described above consecutively to dissolve the contamination. In this case, the changing multiple times may be followed by a comparatively long (for example, 10 seconds) cleaning signal or multiple identical cleaning signals, in particular, in turn, one chirp each, with a transport direction T directed away from the loudspeaker to then transport the dissolved contamination out of the sound tube 14.

The subject of the invention is not limited to the exemplary embodiments described above. Rather, other embodiments of the invention may be derived from the description above by a person skilled in the art. In particular, the individual features of the invention and their design variants described with reference to the various exemplary embodiments may also be combined with one another in other ways.

The following is a summary list of reference numerals and the corresponding structure used in the above description of the invention:
1 Hearing instrument
2 Microphone
4 Microphone
6 Signal processor
8 Loudspeaker
10 Energy source
12 Housing
14 Sound tube
16 Earmold
30 Dots
MS Microphone signal
AS Output signal
A Signal amplitude
t Time
Ac Amplitude
T Transport direction

1. A hearing instrument system, comprising:
a hearing instrument;
a sound conduction channel;
at least one loudspeaker acoustically connected to an environment of said hearing instrument via said sound conduction channel; and
a controller configured to:
ascertain whether at least one starting condition for initiating a cleaning mode for said sound conduction channel is present;
initiate the cleaning mode upon the at least one starting condition being present; and
output an audio signal with a waveform using said at least one loudspeaker during the cleaning mode, and varying a period of the waveform while the audio signal is output.

2. The hearing instrument system according to claim 1, wherein said controller is configured to output a chirp as the audio signal with a varying period.

3. The hearing instrument system according to claim 1, wherein said controller is configured to ascertain a type of fouling of said sound conduction channel and to select the waveform for the audio signal as a function of the fouling.

4. The hearing instrument system according to claim 1, wherein said controller is configured to ascertain a type of fouling of said sound conduction channel and to select a frequency range for the audio signal as a function of the fouling.

5. The hearing instrument system according to claim 3, wherein said controller is configured to, for ascertaining the type of the fouling of said sound conduction channel, perform acoustic feedback measurement, and/or ascertain any resonance detuning of said hearing instrument, and/or evaluate an optical recording of said sound conduction channel.

6. The hearing instrument system according to claim 3, wherein said controller is configured to select a square waveform or a sawtooth waveform as the waveform for the audio signal.

7. The hearing instrument system according to claim 6, wherein said controller is configured to select the sawtooth waveform as the waveform for the audio signal, and to select a slope of a rising edge and a falling edge of the sawtooth waveform as a function of a transport direction within said sound conduction channel.

8. The hearing instrument system according to claim 7, wherein said controller is configured to, within a scope of the cleaning mode, select the audio signal or at least two consecutive audio signals such that the transport direction changes.

9. The hearing instrument system according to claim 2, wherein said controller is configured to select a frequency framework range for the chirp of 50 Hz to 2,000 Hz.

10. The hearing instrument system according to claim 9, wherein said controller is configured to select the frequency framework range for the chirp of 550 Hz to 50 Hz for fouling in a form of a liquid, and/or to select the frequency framework range for the chirp of 100 Hz to 1500 Hz for the fouling in a form of dry particles.

11. The hearing instrument system according to claim 9, wherein said controller is configured to assign different frequency ranges within the frequency framework range to the chirp as a function of a length of said sound conduction channel.

12. The hearing instrument system according to claim 9, wherein said controller is configured to, as the audio signal, superpose two chirps differing regarding their frequency ranges within the frequency framework range and/or in a chirp duration, and to output them using said at least one loudspeaker.

13. The hearing instrument system according to claim 1, wherein said controller is configured to detect an intended wearing situation of said hearing instrument and to block the cleaning mode or to recommend taking out said hearing instrument.

14. The hearing instrument system according to claim 1, wherein said controller is configured to perform a drying mode before the cleaning mode during which the audio signal at a frequency below 20 Hz is output using said at least one loudspeaker.

15. The hearing instrument system according to claim 1, wherein said controller is configured to utilize positioning said hearing instrument in a charger or initiating a charging operation in the charger as the at least one starting condition.

16. The hearing instrument system according to claim 3, wherein said controller is configured to output a chirp as the audio signal.

17. The hearing instrument system according to claim 4, wherein said controller is configured to output a chirp as the audio signal.

18. The hearing instrument system according to claim 5, wherein the optical recording is of an interior side of said sound conduction channel.

19. The hearing instrument system according to claim 6, wherein said controller is configured to output a chirp as the audio signal.

20. The hearing instrument system according to claim 9, wherein said controller is configured to assign different frequency ranges within the frequency framework range to the chirp as a function of a length of said sound conduction channel, namely in a frequency range shifted towards lower frequencies for a comparatively large length.
